(19) United States
(12) Patent Application Publication
(10) Pub. No.: US 2006/0293020 A1
(43) Pub. Date: Dec. 28, 2006

(54) Radio frequency receiver including a limiter and related methods

(75) Inventors: Ronald J. Hash, Palm Bay, FL (US); Robert C. Taylor, Melbourne, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Harris Corporation, Melbourne, FL (US)

(21) Appl. No.: 11/167,335

(22) Filed: Jun. 27, 2005

(51) Int. Cl. H04B 17/00; H04B 1/16

(52) U.S. Cl. 455/334

(57) ABSTRACT

A radio frequency (RF) receiver system includes an antenna element, a receiver circuit, and an RF signal path connecting the antenna element to the receiver circuit. A limiter may be connected to the RF signal path and include a positive voltage clamp for clamping the RF signal path to a positive threshold voltage relative to a voltage reference, and a negative voltage clamp for clamping the RF signal path to a negative threshold voltage relative to the voltage reference. The limiter may further include a controllable resistance connected in series with the RF signal path. A control circuit controls the controllable resistance based upon at least one of the positive voltage clamp and the negative voltage clamp.

### FIELD OF THE INVENTION

The invention relates to the field of radio frequency (RF) circuits, and, more particularly, to an RF limiter and related methods.

### BACKGROUND OF THE INVENTION

A limiter restricts some characteristic of a signal waveform from exceeding a predetermined value within a circuit. A limiter is therefore generally used for wave shaping and circuit protection applications. An example of a limiter circuit used for RF wave shaping is U.S. Pat. No. 3,206,617 to Scaroni, Jr., which discloses a limiter for eliminating unwanted amplitude modulation or noise carried by an RF signal. The limiter includes a pair of diodes connected in series opposition between the source and the load in combination with a pair of diodes connected in parallel opposition and connected in shunt across the source.

An example of a limiter used for circuit protection is U.S. Pat. No. 6,853,264 to Bennett et al., which discloses a power limiter including a plurality of diodes connected in series to a plurality of transmission lines. The different transmission lines can have varying numbers of the series connected diodes thereby limiting the different transmission lines to different voltage levels. Similarly, U.S. Pat. No. 6,784,837 to Revankar et al. discloses a transmit/receive module including a limiter that uses high breakdown voltage PIN diodes. The limiter operates in conjunction with a transmit/receive switch, which also uses high voltage PIN diodes, and a circulator to provide protection for the receiver circuit.

As noted above, a sensitive system circuit can be protected by a switching device, which serves to isolate the sensitive part of the circuit from exposure to excessive input power. For example, U.S. Pat. No. 6,552,626 to Sharpe et al. discloses a protection system including a PIN diode single-pole, single-throw switch (SPST) isolating the receiver from high power transmission pulses of the transmitter in the event there is a bias failure, such as if the PIN diodes are at zero bias. The protection system uses one SPST switch assembly between the transmitter and the antenna and at least two SPST switch assemblies between the antenna and the receiver to achieve this isolation. Likewise, U.S. Pat. No. 5,446,464 to Feldle discloses a transmit/receive switch connected to a transmitter and receiver signal path. The transmit/receive switch includes two semiconductor diodes and each semiconductor diode is coupled to an output of a power amplifier. The outputs of the power amplifiers can be selectively connected to ground thereby creating a short circuit.

Unfortunately, the RF limiters currently available may have significant drawbacks. The RF limiters that operate by providing a short circuit across the input terminals may cause incident energy, such as radar pulses, to be reflected. For broadband RF limiter applications, switches and tuned RF limiters are undesirable because both are typically hard limiters, they are either on or off. Circulators can address the reflection problem, but this is limited to narrow bandwidths, and integration of the circulators into some systems may be unwieldy.

### SUMMARY OF THE INVENTION

In view of the foregoing background, it is therefore an object of the invention to provide an RF limiter having enhanced characteristics, such as relating to reflections and/or wide bandwidth.

This and other objects, features, and advantages in accordance with the invention are provided by a radio frequency (RF) receiver system including at least one antenna element, a receiver circuit, and at least one (RF) signal path connecting the at least one antenna element to the receiver circuit. A limiter may be connected to the RF signal path and include a positive voltage clamp for clamping the RF signal path to a positive threshold voltage relative to a voltage reference, and a negative voltage clamp for clamping the RF signal path to a negative threshold voltage relative to the voltage reference. The limiter may further include a controllable resistance connected in series with the RF signal path, and a control circuit for controlling the controllable resistance based upon at least one of the positive voltage clamp and the negative voltage clamp. Accordingly, the invention may provide a broadband RF limiter having enhanced reflection and/or wide bandwidth characteristics.

The control circuit may switch the controllable resistance from a low resistance to a high resistance based upon at least one of the positive voltage clamp and the negative voltage clamp clamping the RF signal path. The positive voltage clamp may include a first diode and at least one first resistance connected in series therewith between the RF signal path and the voltage reference. The first resistance may include an internal resistance of the first diode. The negative voltage clamp may include a second diode and at least one second resistance connected in series therewith. The second resistance may include an internal resistance of the second diode.

The control circuit may include a capacitor connected in series between the negative voltage clamp and the voltage reference and defining a control signal node with the negative voltage clamp. A filter may be connected between the control signal node and the controllable resistance. The controllable resistance may include a metal semiconductor field effect transistor having a pair of conduction terminals connected in series with the RF signal path and a control terminal connected to the filter. The RF signal path may include a pair of balanced RF signal paths. The controllable resistance may include a respective controllable resistance device in series with each balanced RF signal path.

The limiter may include a monolithic microwave integrated circuit. The antenna element may include at least one dipole antenna element. The dipole antenna element may include a coupling end portion for coupling to an adjacent dipole antenna elements end.

A method aspect of the invention is directed to limiting radio frequency (RF) signals on at least one RF signal path extending between an antenna element and a receiver circuit. The method may include clamping the RF signal path to a positive threshold voltage relative to a voltage reference using a positive voltage clamp, and clamping the RF signal path to a negative threshold voltage relative to the voltage reference using a negative voltage clamp. The method may further include controlling a controllable resistance connected in series with the RF signal path based upon at least one of the positive voltage clamp and the negative voltage clamp.

### BRIEF DESCRIPTION OF THE DRAWINGS

FIG. 1 is a schematic block diagram of a RF receiver system in accordance with the invention.

FIG. 2 is a schematic circuit diagram of a first embodiment of the limiter of the RF receiver system illustrated in FIG. 1.

FIG. 3 is a schematic circuit diagram of a second embodiment of the limiter of the RF receiver system illustrated in FIG. 1.

FIG. 4 is a graph of impedance variation versus power and frequency for an example of the limiter illustrated in FIG. 1.

FIG. 5 is a graph of the change in return loss for a given frequency for an example of the limiter illustrated in FIG. 1.

FIG. 6 is a graph of the change in gain for an example of the limiter illustrated in FIG. 1.

### DETAILED DESCRIPTION OF THE PREFERRED EMBODIMENTS

The invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

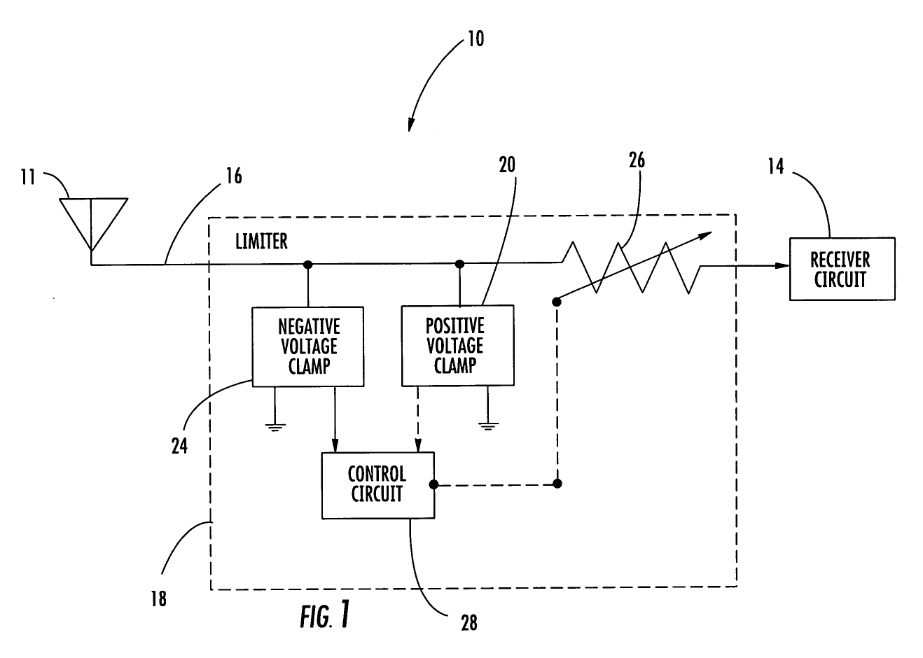

Referring initially to FIG. 1, an RF receiver system 10 in accordance with the invention is now described. The RF receiver system 10 illustratively includes an antenna 11, a receiver circuit 14, and at least one RF signal path 16 connecting the antenna to the receiver circuit as will be appreciated by those of skill in the art. The RF receiver system 10 may be used with any antenna.

A limiter 18 is illustratively connected to the RF signal path 16, and includes a positive voltage clamp 20 for clamping the RF signal path to a positive threshold voltage relative to a voltage reference, and a negative voltage clamp 24 for clamping the RF signal path to a negative threshold voltage relative to the voltage reference. The limiter 18 further includes a controllable resistance 26 connected in series with the RF signal path 16, and a control circuit 28 for controlling the controllable resistance based upon the negative voltage clamp 24. The control circuit 28 may switch the controllable resistance 26 from a low resistance to a high resistance based upon at least one of the positive voltage clamp 20 and the negative voltage clamp 24 clamping the RF signal path 16.

The control circuit 28 may operate based upon the positive voltage clamp 20 in other embodiments as indicated by the dashed connecting line. In yet other embodiments, the control circuit 28 may operate based on both clamps as will be appreciated by those skilled in the art.

As such, the controllable resistance 26 provides broadband burnout protection for the RF receiver circuit 14 as will be appreciated by those skilled in the art. The controllable resistance 26 also provides gradual signal attenuation on the RF signal path 16 that permits the receiver circuit 14 to operate with reduced sensitivity over a wider input power range than a conventional RF limiter (hard limiting) receiver system. The limiter 18 may be in the form of a monolithic microwave integrated circuit, although other circuit configurations are also possible as will be appreciated by those of skill in the art.

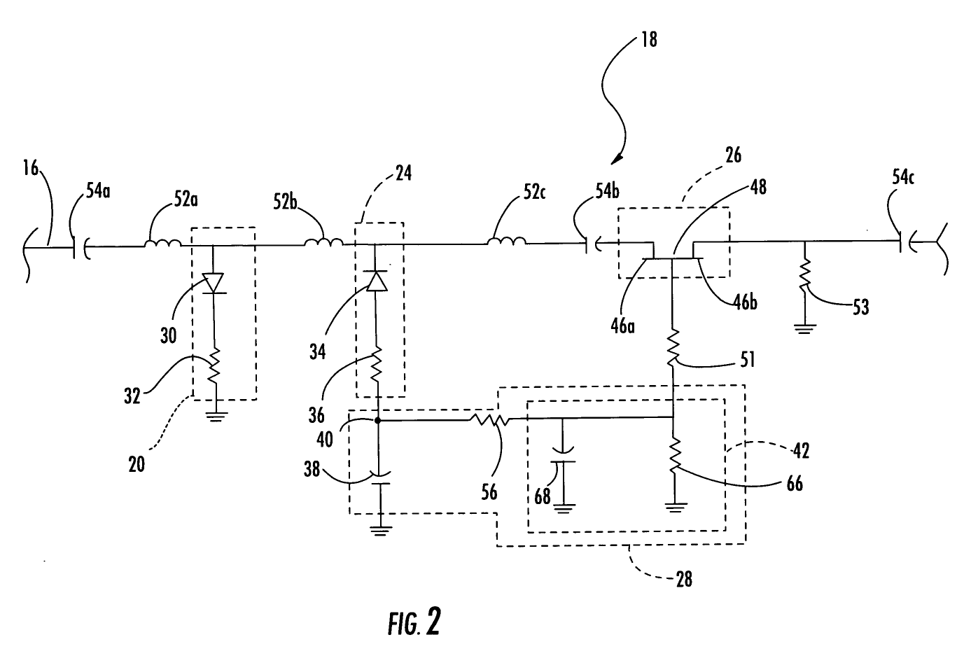

Referring now additionally to FIG. 2, the positive voltage clamp 20 illustratively includes a first diode 30 and a first resistance 32 connected in series therewith between the RF signal path 16 and a voltage reference, e.g. ground. The first resistance 32 may be provided an internal resistance of the first diode 30. Alternately, the first resistance 32 could be a separate component.

The negative voltage clamp 24 illustratively includes a second diode 34 and a second resistance 36 connected in series therewith. The second resistance 36 may be in the form of an internal resistance of the second diode 34 or may be a separate component. The first resistance 32 primarily, and the second resistance 36 are selected to reduce the reflection of a signal on the RF signal path 16 by absorbing the incident energy rather than reflecting it as will be appreciated by those skilled in the art.

The control circuit 28 includes a capacitor 38 connected in series between the second resistance 36 of the negative voltage clamp 24 and the voltage reference to define a control signal node 40 with the negative voltage clamp. A filter 42 is illustratively connected between the control signal node 40 and the controllable resistance 26. The filter 42 illustratively includes a fourth resistance 66 connected in parallel with a filter capacitor 68 to the voltage reference. The control circuit 28 also includes a control circuit resistance 56 connected between the filter 42 and the control signal node 40.

The controllable resistance 26 is illustratively in the form of a metal semiconductor field effect transistor (MESFET) having a pair of conduction terminals 46a, 46b connected in series with the RF signal path 16 and a gate or control terminal 48 connected to the control circuit 28. The limiter 18 also illustratively includes tuning inductors 52a-52c and signal path capacitors 54a-54c, connected to RF signal path 16.

The limiter 18 further includes a resistor 51, which isolates the RF circuit from the filter 42, and a resistor 53, which provides the controllable resistance 26 a bias reference. Both resistors 51 and 53 may be selected with large values when compared to the RF characteristic impedance thereby reducing their affect on the RF signal path 16.

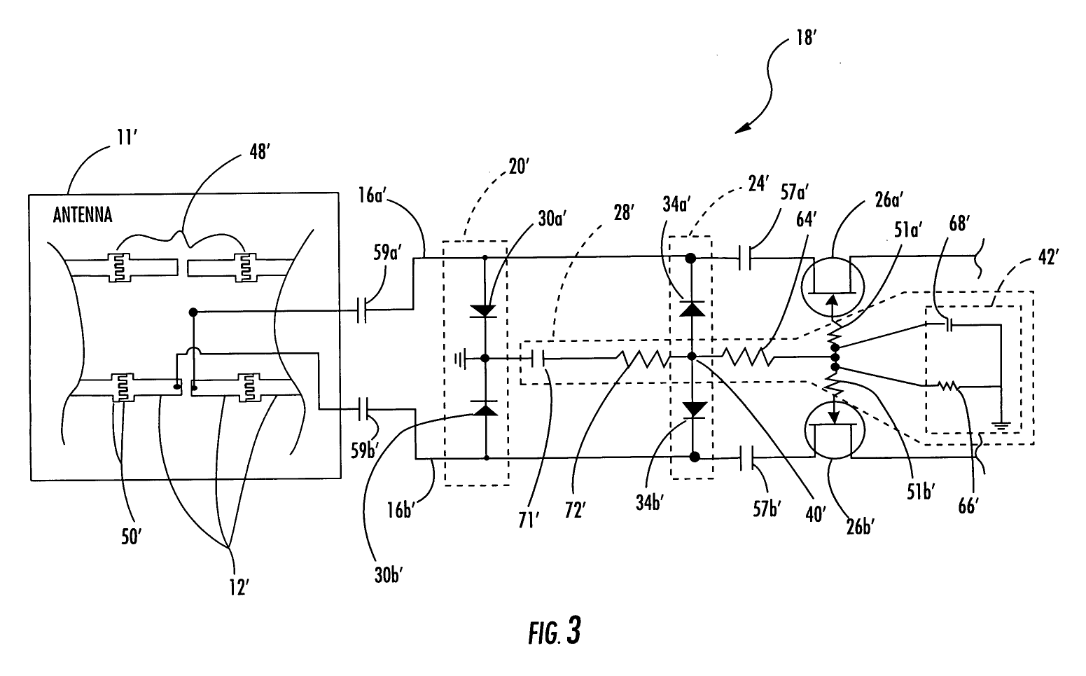

Referring additionally to FIG. 3, in an alternate embodiment, the antenna 11′ is illustratively in the form of a current sheet array antenna and such an antenna has a wide bandwidth. The current sheet array antenna is disclosed in U.S. Pat. No. 6,512,487, the entire contents of which are incorporated by reference herein. The antenna element 12′ illustratively includes a dipole antenna element 48′. The dipole antenna element 48′ includes a coupling end portion 50′ for coupling to an adjacent dipole antenna elements end, for example. The RF signal path includes a pair of balanced RF signal paths 16a′, 16b′ connected to a dipole antenna element 48′. A positive voltage clamp 20′ illustratively includes a pair of diodes 30a′, 30b′ connected between respective signal paths 16a′, 16b′ and ground. Coupling capacitors 57a′, 57b′, 59a′, and 59b′ are provided in respective signal paths 16a′, 16b′. A negative voltage clamp 24′ is illustratively connected between respective signal paths 16a′, 16b′ and includes a pair of diodes 34a′, 34b′.

Each controllable resistance device 26a′, 26b′ includes a control terminal 48′ connected to the control circuit 28′. The control circuit 28′ is connected to control signal node 40′, and it includes the filter 42′. A fifth resistance 64′ is connected between the control signal node 40′ and a sixth resistance 72′. A RF bypass capacitor 71′ is connected between the sixth resistance 72′ and ground.

The limiter 18′ may advantageously operate with a substantially constant impedance while limiting. The limiter 18′ may include additional diodes as will be appreciated by those skilled in the art. The additional diodes should not affect the impedance of the RF receiver system 10.

As the received power increases in the RF receiver system 10, the diodes of the limiter 18′ begin to go into conduction providing limiting. The conduction of the diodes also generates a bias voltage for each controllable resistance 26a′, 26b′ turning them off. The proper selection of the fifth resistance 64′ and the fourth resistance 66′ may be used to adjust the MESFET bias to maintain the match over a range of input power levels. In addition, the fifth resistance 64′ may be used to provide the isolation between the limiter portion of the circuit and the filter 42′.

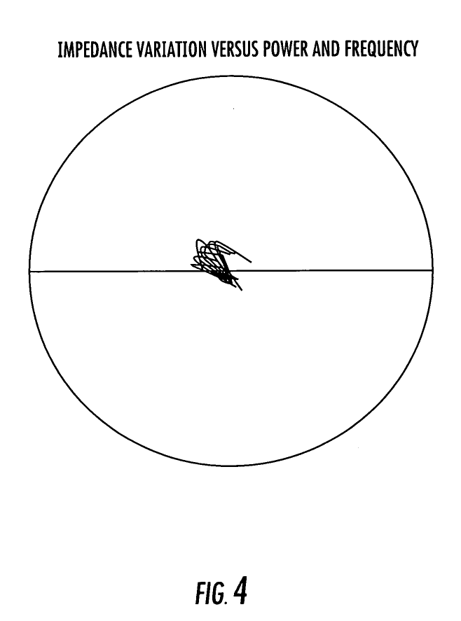

FIGS. 4-6 show a series of graphs illustrating a simulation of the limiter 18′ modeled as a monolithic microwave integrated circuit (MMIC) connected to an antenna. FIG. 4 shows a graph of the complex impedance of the MMIC. Each line shows the change of impedance for a given frequency over an input power range of 10 dBm to 30 dBm, and a frequency range of 2 GHz to 18 GHz in 2 GHz steps.

Each of the curved lines at the center of the graph represents a different frequency, and in an ideal plot, there would only be a dot. The graph shows that each curve turns back towards the center when the diodes 31a, 31b and 33a, 33b turn on because the load resistances 72′ begin absorbing the incident energy. This reduces the amount of incident energy being reflected by the limiter 18′ thereby reducing the reflection of the RF receiver system 10.

The graph also shows that the input impedance changes very little over the power level. In contrast, if this were a conventional limiter, all the curves that start near the center (good match) would end up at the left edge of the chart in a near short circuit condition in which the incident power would be reflected back out of the antenna.

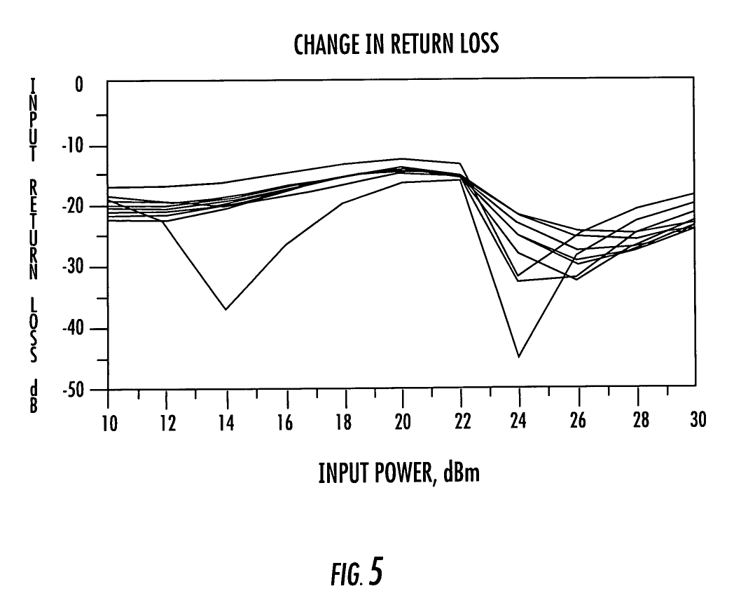

An alternate way to look at the previous simulation results is a graph of the return loss plot as shown in FIG. 5. Again, each return loss line or curve shows the change in return loss for a given frequency from 2 GHz to 18 GHz. In a conventional limiter, the frequency lines would go to 0 dB (total reflection) with increasing power, while the graph shows that the RF receiver system 10 return loss remains within a desirable range.

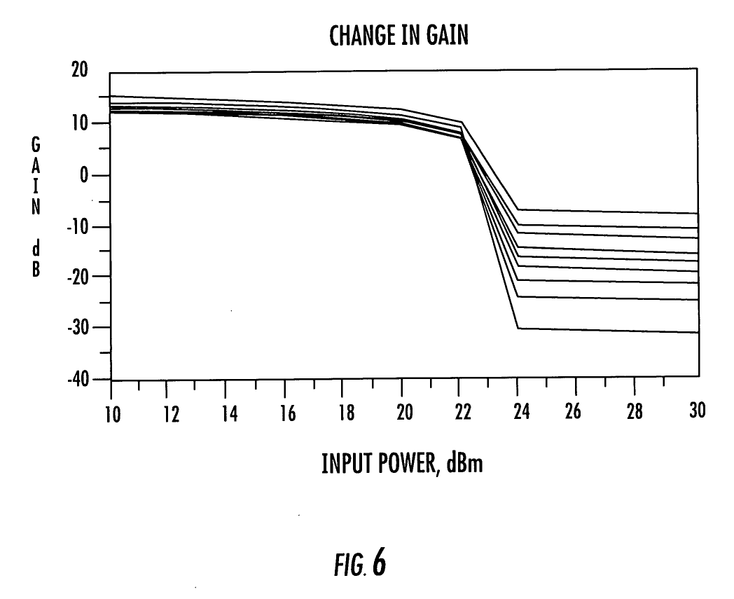

Another highly desirable characteristic of the limiter 18′ is for the limiter to isolate the input power from the more sensitive components of the system. This effect is shown in FIG. 6. Because linear models are used for the active devices in the simulation, no compression effects are produced so the change in gain with increasing power is due to the effect of the limiter 18′.

The graph shows the limiter 18′ starting to operate at 11 dBm and then going to a high attenuation state at higher potentially damaging power levels. The top lines in the plot exhibit 23 dB isolation, which improves to more than 40 dB at the low end of the 2 GHz to 18 GHz frequency band.

A method aspect of the invention is directed to limiting RF signals on an RF signal path 16 extending between an antenna element 12 and a receiver circuit 14. The method may include clamping the RF signal path 16 to a positive threshold voltage relative to a voltage reference using a positive voltage clamp 20, and clamping the RF signal path to a negative threshold voltage relative to the voltage reference using a negative voltage clamp 24. The method may further include controlling a controllable resistance 26 connected in series with the RF signal path 16 based upon at least one of the positive voltage clamp 20 and the negative voltage clamp 24.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that other modifications and embodiments are intended to be included within the scope of the appended claims.

That which is claimed is:

1. A radio frequency (RF) receiver system comprising:
at least one antenna element, a receiver circuit, and at least one (RF) signal path connecting said at least one antenna element to said receiver circuit;
a limiter connected to said at least one RF signal path and comprising
a positive voltage clamp for clamping the at least one RF signal path to a positive threshold voltage relative to a voltage reference,
a negative voltage clamp for clamping the at least one RF signal path to a negative threshold voltage relative to the voltage reference,
a controllable resistance connected in series with the at least one RF signal path, and
a control circuit for controlling said controllable resistance based upon at least one of said positive voltage clamp and said negative voltage clamp.

2. The RF receiver system according to claim 1 wherein said control circuit switches said controllable resistance from a low resistance to a high resistance based upon at least one of said positive voltage clamp and said negative voltage clamp clamping the at least one RF signal path.

3. The RF receiver system according to claim 1 wherein said positive voltage clamp comprises a first diode and at least one first resistance connected in series therewith between the at least one RF signal path and the voltage reference.

4. The RF receiver system according to claim 3 wherein said at least one first resistance comprises an internal resistance of said first diode.

5. The RF receiver system according to claim 3 wherein said negative voltage clamp comprises a second diode and at least one second resistance connected in series therewith.

6. The RF receiver system according to claim 5 wherein said at least one second resistance comprises an internal resistance of said second diode.

7. The RF receiver system according to claim 5 wherein said control circuit comprises:
a capacitor connected in series between said negative voltage clamp and the voltage reference and defining a control signal node with the negative voltage clamp; and
a filter connected between the control signal node and said controllable resistance.

8. The RF receiver system according to claim 7 wherein said controllable resistance comprises a metal semiconductor field effect transistor having a pair of conduction terminals connected in series with the at least one RF signal path and a control terminal connected to said filter.

9. The RF receiver system according to claim 1 wherein said at least one RF signal path comprises a pair of balanced RF signal paths; and wherein said controllable resistance comprises a respective controllable resistance device in series with each balanced RF signal path.

10. The RF receiver system according to claim 1 wherein said at least one limiter comprises a monolithic microwave integrated circuit.

11. The RF receiver system according to claim 1 wherein said at least one antenna element comprises at least one dipole antenna element.

12. The RF receiver system according to claim 11 wherein said at least one dipole antenna element comprises a coupling end portion for coupling to an adjacent dipole antenna element end.

13. A radio frequency (RF) limiter to be connected to at least one RF signal path extending between an antenna element and a receiver circuit, the RF limiter comprising:
a positive voltage clamp for clamping the at least one RF signal path to a positive threshold voltage relative to a voltage reference;
a negative voltage clamp for clamping the at least one RF signal path to a negative threshold voltage relative to the voltage reference;
a controllable resistance connected in series with the at least one RF signal path; and
a control circuit for controlling said controllable resistance based upon at least one of said positive voltage clamp and said negative voltage clamp.

14. The limiter system according to claim 13 wherein said control circuit switches said controllable resistance from a low resistance to a high resistance based upon at least one of said positive voltage clamp and said negative voltage clamp clamping the at least one RF signal path.

15. The limiter according to claim 13 wherein said positive voltage clamp comprises a first diode and at least one first resistance connected in series therewith between the at least one RF signal path and the voltage reference.

16. The limiter system according to claim 15 wherein said at least one first resistance comprises an internal resistance of said first diode.

17. The limiter system according to claim 15 wherein said negative voltage clamp comprises a second diode and at least one second resistance connected in series therewith.

18. The limiter system according to claim 17 wherein said at least one second resistance comprises an internal resistance of said second diode.

19. The limiter system according to claim 17 wherein said control circuit comprises:
a capacitor connected in series between said negative voltage clamp and the voltage reference and defining a control signal node with the negative voltage clamp; and
a filter connected between the control signal node and said controllable resistance.

20. The limiter system according to claim 19 wherein said controllable resistance comprises a metal semiconductor field effect transistor having a pair of conduction terminals connected in series with the at least one RF signal path and a control terminal connected to said filter.

21. The limiter system according to claim 13 wherein the at least one RF signal path comprises a pair of balanced RF signal paths; and wherein said controllable resistance comprises a respective controllable resistance device in series with each balanced RF signal path.

22. A method of limiting radio frequency (RF) signals on at least one RF signal path extending between an antenna element and a receiver circuit, the method comprising:
clamping the at least one RF signal path to a positive threshold voltage relative to a voltage reference using a positive voltage clamp;
clamping the at least one RF signal path to a negative threshold voltage relative to the voltage reference using a negative voltage clamp; and
controlling a controllable resistance connected in series with the at least one RF signal path based upon at least one of the positive voltage clamp and the negative voltage clamp.

23. The method according to claim 22 further comprising switching the controllable resistance from a low resistance to a high resistance based upon at least one of the positive voltage clamp and the negative voltage clamp clamping the at least one RF signal path.
